(19) United States
(12) Patent Application Publication
(10) Pub. No.: US 2008/0034816 A1
(43) Pub. Date: Feb. 14, 2008

(54) Security lock having a hook assembly engageable with a slot

(75) Inventor: Francisco Lu, Kaohsiung (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: MIZ ENGINEERING LTD., Kansan (TW)

(21) Appl. No.: 11/583,928

(22) Filed: Oct. 20, 2006

(30) Foreign Application Priority Data
Aug. 14, 2006 (TW) 095129807

(51) Int. Cl. E05B 73/00

(52) U.S. Cl. 70/58

(57) ABSTRACT

A security lock includes a housing, a pair of intersecting and pivotally interconnected locking arms that respectively have hooks extending outwardly of the housing and heads extending into the housing; and a key-operated lock disposed inside the housing and has a lock shell, and a rotatable core. The core has a tail projecting therefrom to extend between the heads, and includes two opposite first sides and two opposite second sides. A cross-section of the tail that is transverse to the first and second sides has a long distance between the first sides, and a short distance between the second sides. The hooks may be changed in position to engage or disengage a slot formed in an article by merely turning the core using a key.

### CROSS-REFERENCE TO RELATED APPLICATION

This application claims priority of Taiwanese Application No. 095129807, filed on Aug. 14, 2006.

### BACKGROUND OF THE INVENTION

1. Field of the Invention

The invention relates to a security lock, more particularly to a security lock having a hook assembly engageable with a slot provided in an article, such as a computer or a computer peripheral device.

2. Description of the Related Art

To promote international marketing, exhibition centers have been extensively used by manufacturers to display their new products, such as computers, and computer peripheral devices. In order to prevent thief of high price products, such as laptop computers, notebook computers, central processing units, liquid crystal displays, scanners, printers, etc., security locks and cables have been used to lock and fasten the products to fixed structures such as posts, desks, tables, etc.

Referring to FIGS. 1, 2 and 3, there is shown a computer security lock 1 for locking a notebook computer 2. The security lock 1 includes a housing 11 provided with a sleeve 14 and a cap 16. A cable 17 is connected pivotally to lugs 142 of the sleeve 14. Inside the housing 11 are a key-operated lock 12 and a hook assembly 13. The hook assembly 13 includes a pair of locking arms 131 that intersect one another like intersecting blades of a pair of scissors and that are pivoted to a bottom wall 111 within a through hole 113. The locking arms 131 have respective heads 133 biased by springs 132 and respective hooks 134 projecting outwardly of the through hole 113 to engage a slot 20 of a computer 2.

The key-operated lock 12 has a cylinder lock 121 and a locking shaft 122 extending slidably through the cylinder lock 121. When the locking shaft 122 is pressed inward, the key-operated lock 12 is placed in a locking position, and an inner end of the locking shaft 122 extends toward the heads 133 and pushes the same outward against the springs 132, thereby moving the hooks 134 away from each other as shown in FIG. 3. In this situation, the hooks 134 are interlockable with the slot 20 of the computer 2. When the key-operated lock 12 is placed in a locking position by using a tubular key 10, the locking shaft 122 protrudes outward, so that the heads 133 are moved toward each other by the spring 132 and the hooks overlap. In this situation, the hooks 134 are disengaged from the slot 20.

As mentioned above, the cylinder lock 121 is operated by pressing the locking shaft 122 to lock the computer 2 and by inserting the key into the locking shaft 122 to unlock the computer 2. To press the locking shaft 122, the key 10 must be detached from the locking shaft 122. Therefore, if the computer 2 is unlocked or locked mistakenly, the computer 2 must be re-locked or re-unlocked by detaching or re-attaching the key 10 from or to the locking shaft. The need to attach and detach the key 10 to operate the cylinder lock 121 as such is somewhat inconvenient. Besides, the locking shaft 122 protruding from the cylinder lock 121 occupies additional space, and affects adversely the outer appearance of the security lock 1.

### SUMMARY OF THE INVENTION

Therefore, the main object of the present invention is to provide a security lock to overcome the aforementioned drawbacks of the prior art.

According to the present invention, a security lock comprises a housing, a pair of intersecting lock arms, and a key-operated lock. The housing includes a bottom wall, and a tubular wall extending upward from the bottom wall, the bottom wall having a through hole. The locking arms are pivoted to each other, and are further pivoted to the bottom wall within the through hole, the locking arms respectively having hooks extending outwardly of the through hole, and heads extending into an interior of the tubular wall. The key-operated lock is disposed inside the tubular wall, and has a lock shell and a core rotatable relative to the lock shell. The core has a tail projecting therefrom to extend between the heads. The tail includes two opposite first sides and two opposite second sides, and has a cross-section that is transverse to the first and second sides and that has a long distance between the first sides, and a short distance between the second sides. The short distance is shorter than the long distance. When the key-operated lock is an unlocking position, the second sides respectively face the heads without contacting the heads. When the key-operated lock is a locking position, the first sides respectively contact and push the heads so that the heads are moved away from each other.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional security lock;

FIG. 2 is a sectional view of the conventional security lock;

FIG. 3 is the same view as FIG. 2 but showing that hooks of the conventional security lock engage a slot in a computer;

FIG. 4 is a sectional view showing a security lock embodying the present invention;

FIG. 5 is the same view as FIG. 4 but showing that hooks of the security lock of FIG. 4 engage a slot in a computer; and

FIG. 6 is a sectional view showing a tail projecting from a core of the security lock of FIG. 4.

### DETAILED DESCRIPTION OF THE PREFERRED EMBODIMENT

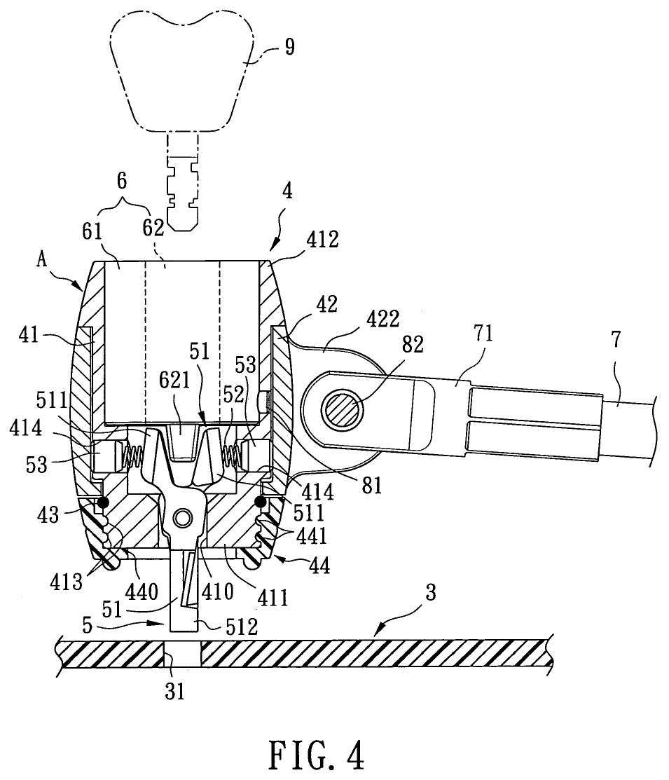

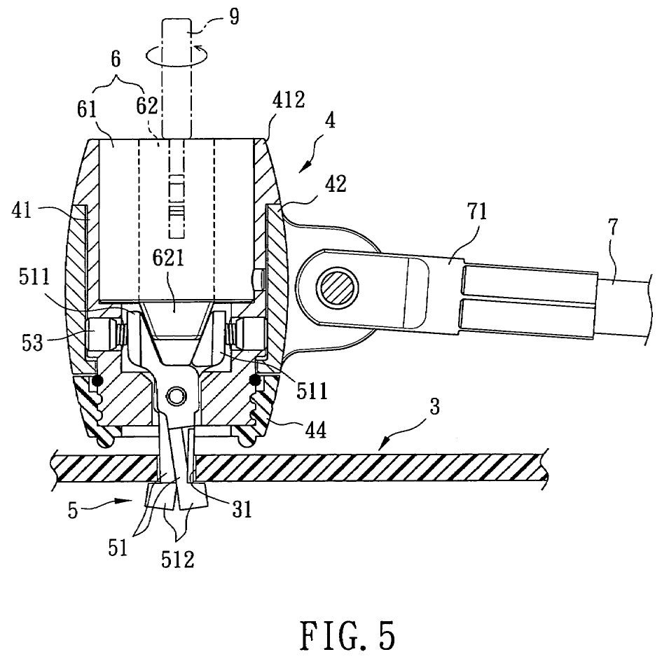

Referring to FIGS. 4 and 5, a security lock (A) embodying the present invention is useful for locking a computer 3 having a slot 31. The computer 3 may be a laptop computer or a notebook computer. The security lock (A) may also be used to lock a central processing unit, a computer display, a printer, a scanner, a projector, etc. The security lock (A) includes a housing 4, a hook assembly 5, a key-operated lock 6, and a cable 7.

The housing 4 has a tubular wall 41 of substantially elliptical cross-section, a bottom wall 411, a sleeve 42 disposed around the tubular wall 41, and a cap 44. The bottom wall 411 has a through hole 410. The tubular wall 41 has a top rim 412 protruding outwardly therefrom, and two opposite retention holes 414 formed therein. A pair of spaced-apart lugs 422 project from the outer periphery of the sleeve 42.

The cap 44 is disposed over the bottom wall 411 and engages the outer periphery of the bottom wall 411 through inter engagement of annular grooves 413 formed in the bottom wall 411 and annular protrusions 441 formed on the cap 44. A limiting ring 43 is fitted in another annular groove 413 formed in the tubular wall 41 and pushes the sleeve 42 against the top rim 412. An opening 440 is provided in a bottom end of the cap 44 to expose the through hole 410 in the bottom wall 411.

The hook assembly 5 includes a pair of locking arms 51 that are pivoted to the bottom wall 411 within the through hole 410, and that intersect each other, and that are interconnected pivotally like intersecting blades of a pair of scissors. The locking arms 51 have respective hooks 512 projecting outwardly of the through hole 410, and further have respective heads 511 extending into the tubular wall 41. The heads 511 are biased respectively by springs 52 to move toward each other so that the hooks 512 are normally moved toward each other and overlap. The springs 52 are connected to respective retainers that are fitted in the retention holes 414, respectively.

The cable 7 has a headed end 71 extending between and pivoted to the lugs 422 of the sleeve 42 by means of a pivot pin 82.

The key-operated lock 6 is a conventional cylinder lock which has a lock shell 61 and a core 62 that is rotatable relative to the lock shell 61 and that can be locked against rotation in a conventional manner using tumblers (not shown). The lock shell 61 is fitted inside the tubular wall 41 and is retained therein in a conventional manner by using a retaining pin 81.

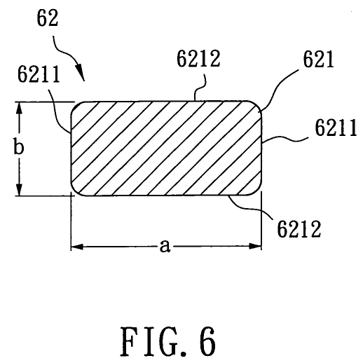

According to the present invention, the core 62 has a tail 621 projecting therefrom and extending between the heads 511 of the locking arms 51. As shown in FIG. 6, the tail 621 has two opposite first sides 6211, and two opposite second sides 6212. The cross-section of the tail 621 that is transverse to the first and second sides 6211, 6212 has a long distance (a) between the first sides 6211, and a short distance (b) between the second sides 6212. The short distance (b) is shorter than the long distance (a).

While the cross-section of the tail 621 is rectangular in this embodiment, it may be elliptical or have any other shape that has a long distance between one pair of opposite sides or ends and a short distance between the other pair of opposite sides or ends.

In use, the hooks 512 of the locking arms 51 are inserted into a slot 31 in a computer 3, and a key 9 is inserted into the core 62 and is turned to rotate the core 62 relative to the lock shell 61 so that the key-operated lock 6 is placed in a locking or unlocking position.

When the key-operated lock 6 is in an unlocking position, the second sides 6212 of the tail 621 face the respective heads 511 of the locking arms 51. As the heads 511 has a spacing therebetween that is longer than the short distance (b), the second sides 6212 of the tail 621 do not contact the heads 511 so that the heads 511 are not pushed by the tail 621. Therefore, the hooks 512 overlap and are not moved away from each other. As a result, the hooks 512 do not engage the slot 31 in the computer 3.

When the key-operated lock 6 is to be placed in a locking position, the key 9 may be turned to rotate the core 62 by an angle of 90 degrees so that the first sides 6211 of the tail 621 face the respective heads 511. As the long distance (a) between the first sides 6211 is longer than the spacing between the heads 511, the first sides 6211 contact and push the respective heads 511 so that the heads 511 are moved away from each other against the actions of the springs 52. Thus, the hooks 512 are moved away from each other and are stretched outward, thereby engaging the slot 31 in the computer 3.

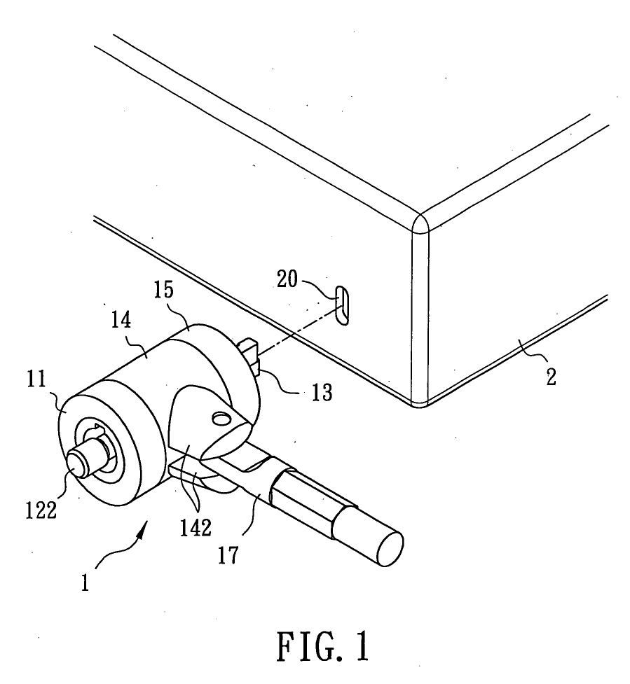

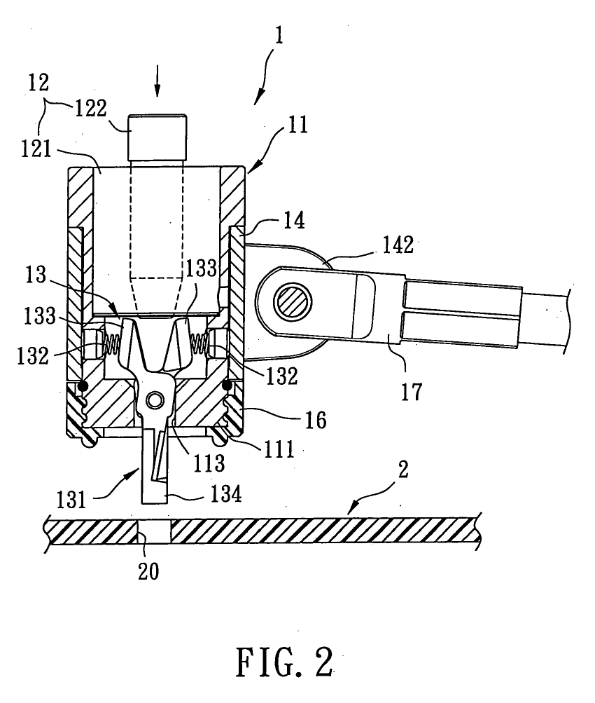

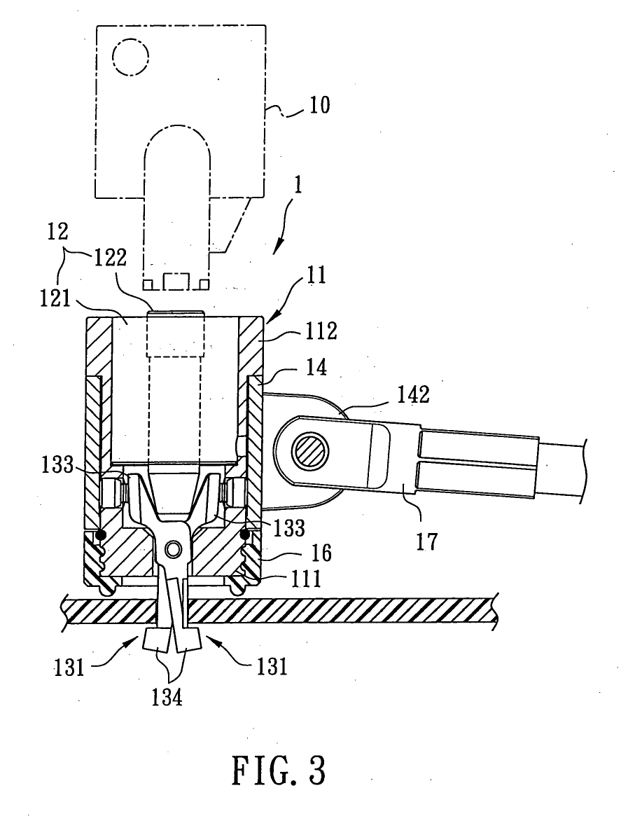

As described above, the key 9 is used to rotate the core 62 to place the key-operated lock 6 either in a locking or unlocking position. The key-operated lock 6 may be shifted between locking and unlocking positions by turning the key 9 to rotate the core 62 by an angle of 90 degrees. In other words, the computer 3 that has been unlocked or locked may be re-locked or re-unlocked by merely turning the key 9 counterclockwise or clockwise by 90 degrees. The key 9 need not be removed from the core 62 to re-lock or re-unlock the computer 3. In addition, the key-operated lock 6 is not provided with any axially slidable locking shaft that is extendable out of the housing 4, the security lock (A) has an improved outer appearance and takes up less space compared to the conventional security lock 1 shown in FIGS. 1-3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A security lock comprising:
a housing having a bottom wall, and a tubular wall extending upward from said bottom wall, said bottom wall having a through hole;
a pair of intersecting locking arms that are pivoted to each other and that are pivoted to said bottom wall within said through hole, said locking arms respectively having hooks extending outwardly of said through hole and having heads extending into an interior of said tubular wall; and
a key-operated lock disposed inside said tubular wall and having a lock shell and a core rotatable relative to said lock shell, said core having a tail projecting therefrom and extending between said heads, said tail including two opposite first sides, and two opposite second sides connected between said first sides, said tail being rotatable to permit said first sides to respectively face said heads, or to permit said second sides to respectively face said heads, said first sides having a long distance therebetween that is large enough to push said heads to move away from each other, said second sides having a short distance therebetween that is short enough to prevent said second sides from contacting said head.

2. The security lock of claim 1, wherein said tail has a rectangular cross section.

3. The security lock of claim 1, wherein said heads have a spacing therebetween when said heads are not pushed by said tail, said short distance being shorter than said spacing, said long distance being longer than said spacing.
